(19) United States
(12) Patent Application Publication
(10) Pub. No.: US 2009/0174397 A1
(43) Pub. Date: Jul. 9, 2009

(54) INTERNAL INSTRUMENTATION SYSTEM FOR A NUCLEAR REACTOR, THE SYSTEM HAVING AN ADVANCED ELECTRONIC CARD, AND A CORRESPONDING METHOD OF MODIFYING AN INTERNAL INSTRUMENTATION SYSTEM OF A NUCLEAR REACTOR

(75) Inventor: Michel Leclerc, Limas (FR)

Correspondence Address: CONNOLLY BOVE LODGE & HUTZ LLP, 1875 EYE STREET, N.W., SUITE 1100, WASHINGTON, DC, 20006, US

(73) Assignee: AREVA NP, Courbevoie (FR)

(21) Appl. No.: 12/295,486

(22) PCT Filed: Feb. 13, 2007
(86) PCT No.: PCT/FR07/00248

§ 371 Date: Sep. 30, 2008

(30) Foreign Application Priority Data
Apr. 13, 2006 (FR) FR 06 03305

(51) Int. Cl. G01B 7/30; G01T 1/00

(52) U.S. Cl. 324/207.25; 250/336.1

(57) ABSTRACT

This internal instrumentation system (3) for a nuclear reactor comprises at least: a probe (7) for measuring the neutron flux in the core (5) of the nuclear reactor; a displacement cable (9) for moving the probe inside the core (5); a rotary drive device (35) for the displacement cable (9); and a determination device (44) for determining the angular position of the rotary drive device (35), which determination device comprises a synchrotransmitter (45) which itself comprises a rotor made to rotate as one with the drive device (35) and a stator having three windings. The device (44) for determining the angular position comprises an electronic unit for digitising at least two of the voltages at the terminals of the stator windings of the synchrotransmitter and for digitally processing these digitised voltages in order to produce at least one output signal representative of the angular position of the rotary drive device (35).

The present invention relates to an internal instrumentation system for a nuclear reactor, the system being of the type comprising at least:
a measurement probe for measuring neutron flux in the core of the nuclear reactor;
a movement cable for moving the probe inside the core;
a rotary device for driving the movement cable; and
an angle-determining device for determining the angular position of the rotary drive device, which angle-determining device comprises a transmitter synchro, itself comprising a rotor constrained to rotate with the drive device and a stator having three windings.

By way of example, the invention applies to pressurized water cooled nuclear reactors for generating electricity for domestic electricity networks.

Nuclear reactors, such as pressurized water cooled nuclear reactors, have a core made up of fuel assemblies that are generally of right prismatic shape and disposed juxtaposed to one another with their longitudinal axes in the vertical direction, i.e. in the height direction of the core.

While the nuclear reactor is in operation, it is necessary to make sure continuously that the reactor is operating under good conditions and in compliance with the general safety conditions as determined by regulations and standards.

In particular, it is necessary to determine whether the production and the volume distribution of the neutron flux and whether the volume distribution of the power released in the core comply with conditions that correspond to normal and satisfactory operation of the core.

That is why it is necessary to determine and calculate operating parameters of the nuclear reactor core, such as the volume distribution of power within the core, form factors for the neutron flux, or indeed the boiling crisis ratio. These parameters are determined in particular on the basis of neutron flux measurements in the core that reveal the neutron flux distribution throughout the core in three dimensions.

The neutron flux measurements in the core that are needed for continuous monitoring of the nuclear reactor in operation are generally performed by chambers located outside the reactor vessel and generally referred to as “excore chambers”.

These chambers have a plurality of measurement levels (e.g. six) in the vertical direction of the core and they are generally disposed so as to perform measurements in four zones at the periphery of the nuclear reactor core, which zones are situated symmetrically about two axial planes of symmetry of the core that are at an angle of 90° to each other.

The chambers of the excore detectors serve to obtain flux measurements at various levels up the height direction of the core and in the four zones distributed around the core, in the circumferential direction. Nevertheless, such external devices provide values of the neutron flux inside the core that are approximate only and they provide a representation of the distribution of the neutron flux that is likewise approximate. As a result, monitoring parameters are obtained in a manner that is not very accurate, and for safety reasons, it is necessary to provide greater margins relative to the critical values for these parameters, since they must not be reached or exceeded.

In order to obtain a more accurate representation of the neutron flux distribution in the core, neutron flux measurements are also performed inside the core in complementary manner at time intervals that are regular but quite long, for example once a month, these measurements being performed by using very small moving measurement probes referred to as “incore probes”, that are generally constituted by fission chambers. Such moving probes form parts of the internal instrumentation system of the nuclear reactor, also referred to as the reactor in-core (RIC) system.

Incore probes are fastened to the ends of respective flexible cables, for example a cable from the supplier Téléflex, that enable them to be moved inside a measurement path of the internal instrumentation system of the nuclear reactor. Each of these measurement paths opens out at one of its ends into an instrumentation room situated in the low part of the reactor building. The fission probes are moved along the measurement paths from the instrumentation room by control units that include rotary drive devices for driving the cables, e.g. devices in the form of gearwheels.

Inside the nuclear reactor core, each measurement path comprises an instrumentation tube of a fuel assembly and a thimble located inside the instrumentation tube in which the fission probe is to travel. Neutron flux measurements are performed in measurement tubes constituted by the vertically-extending instrumentation tubes of a set of fuel assemblies distributed throughout the section of the core.

For example, for a core having one hundred seventy-seven fuel assemblies, it is common practice to use fifty-six measurement paths. Fifty-eight measurement paths are used for a core having one hundred ninety-three fuel assemblies, forty-eight or fifty measurement paths for a core having one hundred fifty-seven fuel assemblies, and sixty measurement paths for a core having two hundred five fuel assemblies.

Neutron flux measurements are performed while the moving incore probes are traveling slowly along the full height of the core. It is thus possible to obtain numerous measurement points in the neutron flux in the height direction of the core, with the points being placed close together. For example, it is possible to take measurements at six hundred points that are distributed along the height of each measurement tube. Furthermore, given the distribution of instrumented fuel assemblies in the core, and given symmetries of the core, a sufficiently representative image is obtained of the neutron flux in the form of a flux map. The flux map is determined accurately only periodically by using moving probes, in the context of known operating procedures.

In order to obtain a flux map that is correct, it is necessary to know the exact positions of the probes within the nuclear reactor core while acquiring flux measurements.

For that purpose, in internal instrumentation systems of the above-described type, a device is used for determining the angular position of the wheel for driving the probe movement cable that moves the probe whose position is to be determined. The angle-determining device comprises a transmitter synchro that is placed in the instrumentation room, itself located in the nuclear reactor building, and a receiver synchro that is remote from the reactor building and that is generally located in or close to the nuclear reactor control room.

The transmitter synchro comprises a rotor provided with a winding that is powered with a modulating alternating voltage, e.g. at 220 volts (V) and at a frequency of 50 hertz (Hz). This rotor is constrained to rotate with the drive wheel. The transmitter synchro also has a stator provided with three windings placed at 120° relative to one another. The magnetic field that results from rotation of the rotor generates voltages at the terminals of the stator windings, which voltages are of amplitudes that depend on the angular position of the rotor, and thus of the drive wheel.

The receiver synchro is of analogous structure and operates on the inverse principle. The three windings of its stator are powered by voltages coming from the terminals of the stator windings of the transmitter synchro and they create a magnetic field of orientation that reproduces the angular position of the rotor of the transmitter synchro. The rotor of the receiver synchro then aligns itself on this magnetic field and in an angular position that therefore depends on the position of the drive wheel and thus of the corresponding neutron flux measurement probe.

The device for determining the angular position of the wheel also has a coder or two absolute coders coupled to the rotor of the receiver synchro and delivering signals to a corresponding controller of the monitoring and control cabinet of the internal instrumentation system. The controller makes use of these signals in order to determine the exact positions of the probes. The positions as determined in this way and the measurements taken by the probes are transmitted by the controller to a power plant computer that draws up the flux map.

The receiver synchro and absolute coders corresponding to each of the moving neutron flux detector probes are disposed in drawers provided in the top portions of the monitoring and control cabinet of the internal instrumentation system of the reactor.

The devices for determining the angular positions of the drive wheels, each of which uses two synchromachines that are coupled to each other, enable the absolute coders to be remote from the control units of the instrumentation room that is situated close to the reactor vessel, which control units are subjected to ionizing radiation that is harmful to absolute coders since they are optoelectronic devices.

Such devices for determining the angular positions of drive wheels are therefore satisfactory but they are complex to maintain.

An object of the invention is thus to solve this problem by providing an internal instrumentation system of the above-specified type that is easier to maintain.

To this end, the invention provides an internal instrumentation system of the above-specified type, characterized in that the angle-determining device comprises an electronic assembly for digitizing at least two voltages at the terminals of the windings of the transmitter synchro stator and for digitally processing these digitized voltages to produce at least one output signal representative of the angular position of the rotary drive device.

In particular embodiments of the invention, the system may include one or more of the following characteristics taken in isolation or in any technically feasible combination:
the system includes a monitoring and control cabinet, which cabinet is designed to be located outside the nuclear reactor building and to contain the electronic assembly;
the electronic assembly comprises:
   a module for determining the voltages at the terminals of the windings of the transmitter synchro stator;
   optionally a module for adapting the determined voltages;
   a module for digitizing at least two of the determined and optionally adapted voltages; and
   a module for digitally processing the digitized voltages;
the electronic assembly includes a module for producing incremental coder type output signals;
the angle-determining device is suitable for determining the position of the probe by digitally processing the digitized voltages, and the electronic assembly includes a module for producing absolute coder type output signals;
the electronic assembly is an assembly for digitizing only two voltages of the determined and optionally adapted voltages;
the electronic assembly includes a module for detecting a drop in voltage and suitable for triggering backup of the determined position;
the electronic assembly includes a module for setting the determined position, which module is designed to be connected to a microswitch of state that is modified by the probe passing a determined position; and
the electronic assembly includes a generator for powering a winding of the rotor of the transmitter synchro with modulation voltage.

The invention also provides a method of modifying an internal instrumentation system of a nuclear reactor, the internal instrumentation system comprising at least:
a measurement probe for measuring neutron flux in the core of the nuclear reactor;
a movement cable for moving the probe inside the core;
a rotary device for driving the movement cable; and
an angle-determining device for determining the angular position of the rotary drive device, which angle-determining device comprises a transmitter synchro, a receiver synchro, and at least one position coder, the transmitter synchro itself comprising a rotor constrained to rotate with the rotary drive device and a stator including three windings, the receiver synchro itself comprising a rotor constrained to rotate with the position coder and a stator having three windings connected to the windings of the transmitter synchro stator;

the method being characterized in that it comprises a step of replacing the receiver synchro and the position coder by an electronic assembly for digitizing at least two voltages at the terminals of the windings of the transmitter synchro stator, and for digitally processing the digitized voltages so as to produce at least one output signal representative of the angular position of the rotary drive device.

The invention can be better understood on reading the following description given purely by way of example and made with reference to the accompanying drawings, in which:

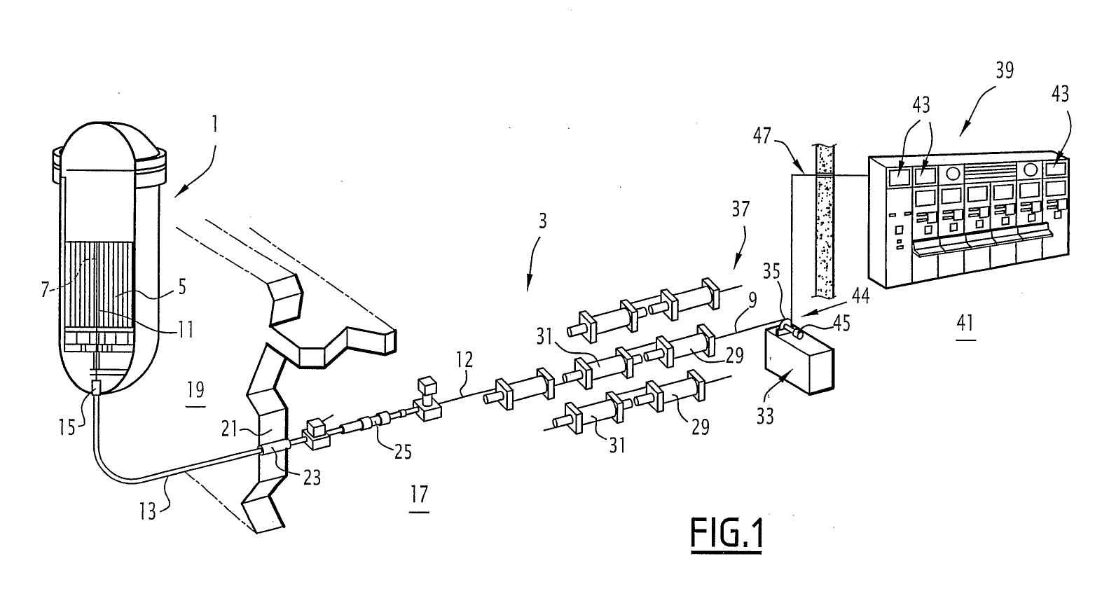

FIG. 1 is a diagrammatic perspective view of an internal instrumentation system of the invention for a pressurized water nuclear reactor;

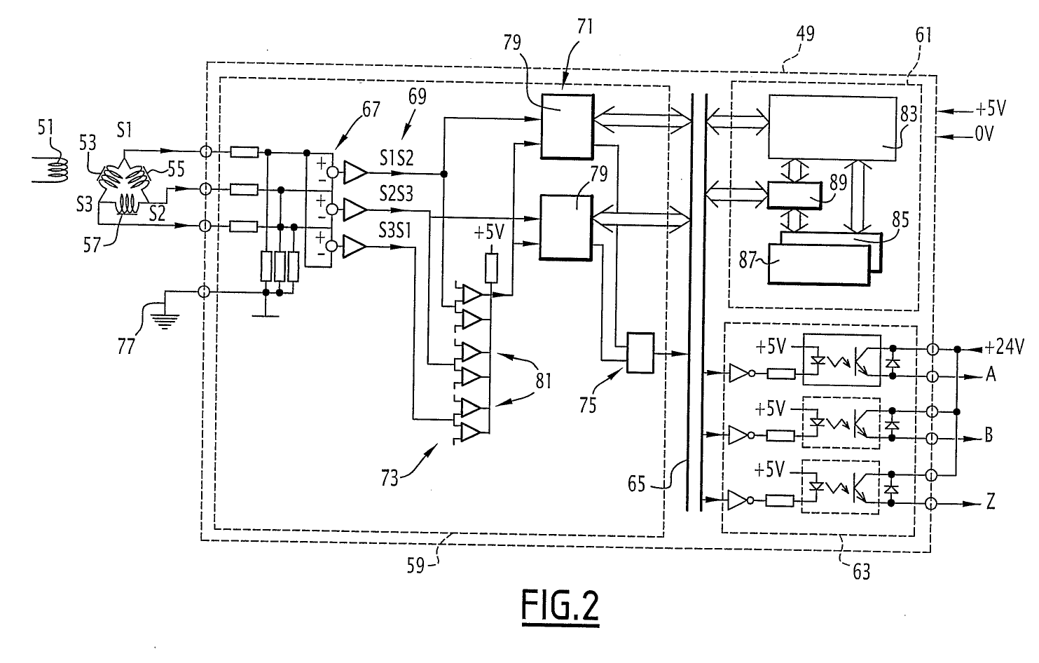

FIG. 2 is a diagram representing an electronic card of the FIG. 1 system; and

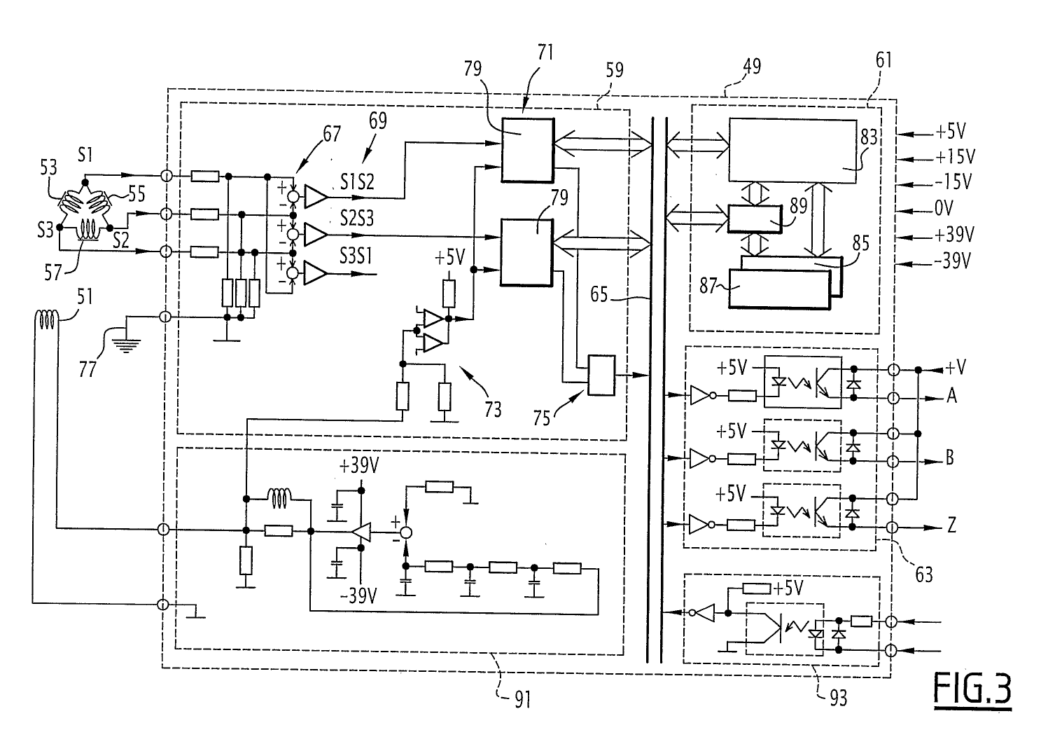

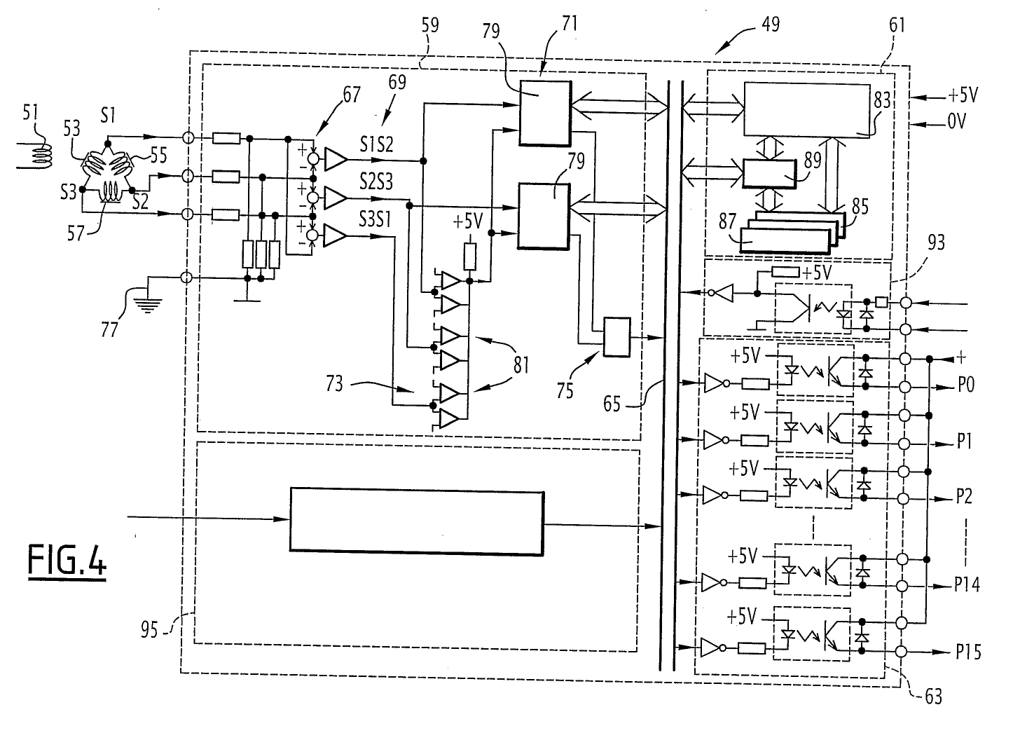

FIGS. 3 and 4 are views analogous to FIG. 2 showing other embodiments of the invention.

FIG. 1 shows the vessel 1 of a pressurized water nuclear reactor together with a portion of the internal instrumentation system 3 of the nuclear reactor. Inside the vessel 1 there is located the core 5 of the reactor made up of juxtaposed fuel assemblies of prismatic shape extending vertically. Each fuel assembly of the reactor core 5 has an instrumentation guide tube, in a vertical position inside the core 5. Neutron flux measurements are taken by moving flux measurement probes 7 vertically inside the instrumentation guide tubes of some of the assemblies of the core, the probes being fastened to the ends of cables 9 that are used for moving the probes 7 by applying thrust or traction to the cables 9, and that are also used for delivering the signals from the probes 7. In FIG. 1, a probe 7 is shown in an intermediate position within the core 5.

By way of example, FIG. 1 shows an instrumentation guide tube 11 forming part of a measurement path of the internal instrumentation system 3. By way of example, the internal instrumentation system 3 may comprise thirty-eight to sixty measurement paths. The terminal portion inside the core 5 of each of the paths is constituted by a guide tube of a fuel assembly analogous to the tube 11.

The guide tubes 11 of the neutral flux measurement paths are distributed throughout the section of the core 5, and flux measurements are taken over the entire height of the core by moving the measurement probe 7.

Each of the measurement paths includes a thimble 12, i.e. a tube that is closed at one of its ends, in which it is possible to move a flux measurement probe 7 by means of its connection and movement cable 9. The thimble 12 is inserted inside the reactor core 5 within a guide tube 11 of a fuel assembly.

The thimble 12 is taken to said guide tube 11 inside an instrumentation guide duct 13 that connects a sleeve 15 passing through the bottom of the reactor vessel 1 to an instrumentation room 17. The room 17 is located adjacent to the portion 19 of the reactor building known as the reactor pit in which the vessel 1 of the reactor is located. The instrumentation room 17 and the reactor pit 19 form part of the reactor building.

The instrumentation guide duct 13 passes through the concrete wall 21 that separates the instrumentation room 17 from the reactor pit 19, passing via a sealed penetration device 23. The end of the instrumentation guide duct 13 that penetrates into the instrumentation room 17 is connected to a seal assembly 25 through which the thimble 12 is inserted in sealed manner to the inside of the instrumentation guide duct 13, one end of the thimble 12 being accessible inside the instrumentation room 17.

The thimble 12 can be moved inside the instrumentation guide duct 13 and inside the nuclear reactor vessel 1 over the full height of the core 5 within an instrumentation guide tube 11 of a fuel assembly between an insertion position and a position where it is extracted from the core 5 of the nuclear reactor.

The thimbles 12 of all of the measurement paths of all the internal instrumentation system of the nuclear reactor are placed in their positions extracted from the core, prior to an operation of reloading the core.

In contrast, while the nuclear reactor is in operation, the thimbles 12 of the various measurement paths of the internal instrumentation system 3, each having a flux measurement probe 7 movable therein, occupy their maximally-inserted positions inside the reactor core 5.

The various measurement paths of the internal instrumentation system constitute a plurality, generally four to six, of groups of paths, each group comprising about ten measurement paths.

Flux measurements are performed in each path of a measurement path group by using a neutron flux probe 7 fixed to the end of a connection and movement cable 9 that is caused to pass successively through a group selector 29 and a path selector 31 in order to be inserted in the thimble 12 of a measurement path as defined by controlling the selectors 29 and 31.

Each of the connection and drive cables 9 for a measurement probe 7 is driven by a control unit 33 including a motor and gearbox unit (not shown) driving a gearwheel 35 meshing with the cable 9 for driving the probe 7. In a variant, the wheel 35 is not necessarily a gearwheel, and it could also be replaced by other rotary drive devices. The probe 7, the connection and drive cable 9 for the probe 7, and the control unit 33 constitute a measurement channel 37. Typically, the internal instrumentation system 3 has four to six measurement channels.

Each control unit 33 also has a winder (not shown) for storing the cable 9 for driving the probe and for exerting a constant return force on the cable 9, both when the cable 9 is moving in the insertion direction and when it is moving in the extraction direction along a measurement path.

The internal instrumentation system 3 is controlled by a distribution cabinet (not shown) located in the instrumentation room 17, in turn connected to a monitoring and control cabinet 39 located in the reactor control room 41 or in the proximity thereof. The distribution cabinet comprises four to six identical subassemblies for controlling the four to six measurement probes 7, each connected to a connection and moving cable 9, each of the subassemblies of the distribution cabinet being connected to a respective automatic channel controller of the monitoring and control cabinet 39.

The movements of the probes 7 and the selections made by the selectors 29 and 31 are thus controlled so as to take flux measurements in succession in each of the measurement paths of the internal instrumentation system 3.

The automatic controller associated with each measurement channel 37 mainly performs the following functions:
controlling the electrical mechanisms of the instrumentation room 17, and in particular the group selectors 29, the path selectors 31, and the control units 33 so as to ensure that the probes 7 performed the required movements and measurements in automatic and/or manual manner; and
conveying measurements taken by the probes 7 to the power plant computer that is located in the nuclear reactor control room 41 or in the vicinity thereof, so as to enable the computer to map the neutron flux.

In order to perform this second function, the automatic controllers associated with the measurement channels 37 receive the measurements required by the probes 7 via drawers disposed in the top bays 43 of the monitoring and control cabinet 39.

Each of the drawers associated with a channel 37 also delivers information provided by a device 44 for determining the angular position of the corresponding drive wheel 35.

The angle determining device 44 comprises a conventional transmitter synchro 45 having its rotor constrained to rotate with the wheel 35. The transmitter synchro 45 is thus located in the instrumentation room 17 and it is connected to the corresponding electrical drawer of the monitoring and control cabinet 39 by a line 47.

In accordance with the invention, the device 44 for determining angular position also comprises, in the associated drawer unit of the monitoring and control cabinet 39, an electronic assembly 49 for digitizing the voltages coming from the transmitter synchro 45.

This electronic assembly 49 may be implemented in the form of a card as shown in FIG. 2. It can be seen that the left-hand portion of FIG. 2 has a diagrammatic representation of the winding 51 of the rotor of the transmitter synchro 45 together with the three windings 53, 55, and 57 of the stator of the transmitter synchro 45. In the example shown, the windings 53, 55, and 57 are connected in a delta configuration, however in a variant they could be connected in a star configuration.

The electronic assembly 49 includes a unit 59 for prior processing of the signals coming from the transmitter synchro 45, a digital processor unit 61, and a unit 63 for producing signals that are representative of the position of the wheel 35, these units communicating with one another via a bus 65.

The prior processing unit 59 comprises:
a module 67 for determining the voltages at the terminals of the windings 53, 55, and 57, i.e. between their terminals S1, S2, and S3, which voltages are written respectively S1S2, S2S3, and S3S1;
a module 69 for adapting these voltage S1S2, S2S3, and S3S2;
a module 71 for digitizing the adapted voltages S1S2 and S2S3;
a module 73 for triggering digitization; and
a module 75 for detecting when the digitizations have come to an end.

In the example described, the winding 51 of the rotor of the transmitter synchro 45 may be powered with a 220 V modulation voltage at a frequency of 50 Hz. The voltages between the terminals S1, S2, and S3 of the windings 53, 55, and 57 are thus modulated at 50 Hz, and their amplitudes depend on the angular position of the rotor of the transmitter synchro 45, and thus of the wheel 35. The module 67 is connected to the terminals S1, S2, and S3 and it determines the voltages S1S2, S2S3, and S3S1 by subtracting the signals delivered by the terminals S1, S2, and S3 so as to accommodate the lack of a neutral voltage. Nevertheless, an intermediate voltage is reconstructed and, for safety reasons, it is connected to ground at 77.

The voltages S1S2, S2S3, and S3S1 output from the module 67 may have peak amplitudes of 80 V. The adaptation module 69 comprises amplifiers that serve to reduce their amplitudes, for example so as to reach maximum peak amplitudes of about 10 V.

The digitizer module 71 comprises, for example, two converters 79 which, likewise by way of example, are converters on eleven bits plus one sign bit. These two converters 79 are triggered synchronously with the modulation of the signals coming from the terminals S1, S2, and S3 of the stator of the transmitter synchro 45, and thus with the voltage powering the winding 51 of the rotor of the transmitter synchro 45.

This synchronization is achieved by means of a series of window comparators 81 that trigger conversions of the voltages S1S2 and S2S3 by means of the converters 79 when at least one of the signals S1S2, S2S3 or S3S1 reaches a predetermined amplitude. The end of digital conversions is signaled from the module 75 to the digital processor unit 61 via the bus 65 which also communicates with the outputs from the converters 79.

The digital processor unit 61 comprises a microcontroller 83, memories, e.g. a random access memory (RAM) 85 and a read only memory (ROM) 87, and means 89 for switching data between the microcontroller 83, the memories 85 and 87, and the bus 65.

The digital processor unit 61, and in particular the microcontroller 83 performs digital processing on the voltages S1S2 and S2S3 after they have been adapted and digitized by the unit 59 in order to determine the angular position of the rotor of the transmitter synchro 45.

The parameters taken into account for digital processing are as follows:
the coding unit or “coding step-size” is such that one revolution of the rotor of the transmitter synchro 45 corresponds to 1024 steps;
the angular position P of the rotor of the transmitter synchro 45 is expressed in steps, in the form of a signed integer; and
one step corresponds approximately to the corresponding probe 7 moving through 1 millimeter (mm), the travel speed possibly reaching 300 mm per second.

The mathematical equations are as follows:
for an angular position P expressed in steps, the voltages received have the following values at each instant t expressed in seconds:

S1S2(P,t)=84*sin(P*π/512)*sin(100*π*t)

S2S3(P,t)=84*sin(P*π/512)+(2π/3))*sin(100*π*t)

S3S1(P,t)=84*sin(P*π/512)−(2*π/3))*sin(100*π*t);

and
at all times, S1S2(P,t)+S2S3(P,t)+S3S2(P,t)=0, which explains why only two of the voltages, here S1S2 and S2S3 are digitized.

On this basis, the unit 61 determines the angular position P, and subsequently the angular P is processed so as to lie in a range −512 steps to +511 steps.

Once the angular position P has been determined and processed by the digital processor unit 61, it is subsequently converted into incremental coder type output signals A, B, and Z by the unit 63. These signals A, B, and Z are processed by the controller of the cabinet 39 associated with the measurement channel 37 under consideration so as to determine the absolute position of the probe 7. This processing may also take account of the state of the electrical mechanisms of the instrumentation system 3, and in particular of microswitches.

It should be observed that the angular position is initialized by a prior origin-determining sequence. Thus, the first movement after switching on a probe 7 must be to return it to an origin position. Thereafter, the unit 61 determines the angular position P relative to the origin position.

The above-described internal instrumentation system 3 thus has electronic cards 49 taking the place of the receiver synchros and absolute coders that are usually provided in the top bays 43 of the monitoring and control cabinet 39.

Maintenance of the instrumentation system 3 is thus simplified since it suffices to remove the corresponding drawers and replace any electronic cards 49 where necessary, instead of repairing or changing the components of the receiver synchro or of the absolute coders.

Furthermore, the cabinet 39 presents little weight in the bays 43, which is advantageous in terms of complying with constraints associated with accommodating seismic risks.

Furthermore, it should be observed that conventional internal instrumentation systems 3 can be adapted easily to include an advanced device 44 as described above. For this purpose, it suffices to replace the receiver synchros and the absolute coders that have been used in the past with electronic cards 49 of the kind described above.

FIG. 3 shows a second embodiment of an electronic card 49 that includes a generator 91 for powering the winding 51 of the rotor of the transmitter synchro 45.

In this embodiment, the power supply voltage that is produced may be a voltage of 26 V at a frequency of 400 Hz. Such a frequency, higher than the frequency of 50 Hz, enables better accuracy to be obtained since it becomes pointless to interpolate. It should also be observed that the structure of the module 73 for triggering digital conversion can be simplified since the modulation voltage is available directly from the generator 91 on the card 49.

In addition, the card 49 includes a module 93 for setting the determined angular position that is connected to a microswitch disposed at a predefined position along the travel path of the probe 7. Thus, when the probe 7 goes past this predefined position, the microswitch changes state and a signal is delivered by the module 93 to the digital processor unit 61 which compares the angular position P as determined with the angular position Pe that actually corresponds to the position of the microswitch, and corrects the value of P so that it matches Pe, should that be necessary.

FIG. 4 shows a third embodiment that differs from the first by the fact that the unit 61 determines the absolute position of the probe 7 directly, by the fact that the card 49 also has a module 93 for setting a determined absolute position, and by the fact that the unit 63 for producing signals representative of position is a unit for producing absolute position signals, specifically signals coded on sixteen bits. The signals that are produced, representing the angular position of the wheel 35, are thus signals representative of the absolute position of the probe 7.

The card 49 also has a module 95 for detecting a drop in voltage for the purpose of triggering a backup of the absolute position as determined by the digital processor unit 61. Here likewise, as in the second embodiment, possible resetting of the determined absolute position is provided automatically by a change in the state of the microswitch connected to the module 93.

The above-described principles can be applied to nuclear reactors having a variety of sizes.

In addition, various numbers of measurement channels may be involved and, for example, it is possible to use a single electronic card for a plurality of measurement channels.

1. An internal instrumentation system for a nuclear reactor, the system being of the type comprising at least:
a measurement probe for measuring neutron flux in the core of the nuclear reactor;
a movement cable for moving the probe inside the core;
a rotary device for driving the movement cable; and
an angle-determining device for determining the angular position of the rotary drive device, which angle-determining device comprises a transmitter synchro itself comprising a rotor constrained to rotate with the drive device and a stator having three windings (53, 55, 57);
the system being wherein the angle-determining device comprises an electronic assembly for digitizing at least two voltages (S1S2, S2S3, S3S1) at the terminals of the windings of the transmitter synchro stator and for digitally processing these digitized voltages to produce at least one output signal (A, B, Z; P0-P15) representative of the angular position of the rotary drive device.

2. A system according to claim 1, wherein it includes a monitoring and control cabinet, which cabinet is designed to be located outside the nuclear reactor building and to contain the electronic assembly.

3. A system according to claim 1, wherein the electronic assembly comprises:
a module for determining the voltages (S1S2, S2S3, S3S1) at the terminals of the windings (53, 55, 57) of the transmitter synchro stator;
optionally a module for adapting the determined voltages;
a module for digitizing at least two of the determined and optionally adapted voltages (S1S2, S2S3); and
a module for digitally processing the digitized voltages.

4. A system according to claim 1, wherein the electronic assembly includes a module for producing incremental coder type output signals (A, B, Z).

5. A system according to claim 1, wherein the angle-determining device is suitable for determining the position of the probe by digitally processing the digitized voltages, and in that the electronic assembly includes a module for producing absolute coder type output signals (P0-P15).

6. A system according to claim 1, wherein the electronic assembly is an assembly for digitizing only two voltages (S1S2, S2S3) of the determined and optionally adapted voltages.

7. A system according to claim 1, wherein the electronic assembly includes a module for detecting a drop in voltage and suitable for triggering backup of the determined position.

8. A system according to claim 1, wherein the electronic assembly includes a module for setting the determined position, which module is designed to be connected to a microswitch of state that is modified by the probe passing a determined position.

9. A system according to claim 1, wherein the electronic assembly includes a generator for powering a winding (51) of the rotor of the transmitter synchro with modulation voltage.

10. A method of modifying an internal instrumentation system of a nuclear reactor, the internal instrumentation system comprising at least:
a measurement probe for measuring neutron flux in the core of the nuclear reactor;
a movement cable for moving the probe inside the core;
a rotary device for driving the movement cable; and
an angle-determining device for determining the angular position of the rotary drive device, which angle-determining device comprises a transmitter synchro, a receiver synchro, and at least one position coder, the transmitter synchro itself comprising a rotor constrained to rotate with the rotary drive device and a stator including three windings (53, 55, 57), the receiver synchro itself comprising a rotor constrained to rotate with the position coder and a stator having three windings connected to the windings of the transmitter synchro stator;
the method being wherein it comprises a step of replacing the receiver synchro and the position coder by an electronic assembly for digitizing at least two voltages (S1S2, S2S3, S3S1) at the terminals of the windings of the transmitter synchro stator, and for digitally processing the digitized voltages so as to produce at least one output signal (A, B, Z; P0-P15) representative of the angular position of the rotary drive device.
